(19) United States
(12) Patent Application Publication
(10) Pub. No.: US 2020/0278511 A1
(43) Pub. Date: Sep. 3, 2020

(54) RIBBONIZING METHODS AND ASSEMBLIES

(71) Applicant: AFL Telecommunications LLC, Duncan, SC (US)

(72) Inventors: Lucas Mays, Greenville, SC (US); Doug Duke, Simpsonville, SC (US)

(21) Appl. No.: 16/288,675

(22) Filed: Feb. 28, 2019

(51) Int. Cl. G02B 6/44

(52) U.S. Cl. CPC G02B 6/448

(57) ABSTRACT

A method for ribbonizing a plurality of loose optical fibers includes aligning the plurality of loose optical fibers in a co-planer array. The method further includes securing the aligned plurality of loose optical fibers in a predetermined pitch spacing, wherein each of the plurality of optical fibers is free from others of the plurality of optical fibers. The method further includes loading the loose optical fibers into a fiber holder.

### FIELD

The present disclosure relates generally to improved methods and assemblies for ribbonizing loose optical fibers.

### BACKGROUND

In the fiber optics industry, optical fibers are frequently spliced, stripped, cleaned, cleaved, and/or otherwise processed for a variety of purposes. In many cases, the optical fibers are ribbonized, such that the fibers are suitably arranged and, in many cases, color-coded, prior to processing.

Known ribbonizing processes typically involve gluing or taping of the optical fibers together. Such processes are time-consuming and imprecise, and can further cause contamination of machines such as splicers which are utilized in the subsequent processing of the optical fibers. Accordingly, improved ribbonizing methods and apparatus which are more efficient and precise, and which can reduce or prevent such contamination risks, would be advantageous.

Further, conventionally known optical fibers and fiber optic ribbons utilize nominal 250 micron diameter optical fibers. However, recently, nominal 200 micron diameter optical fibers have been developed. This size reduction inhibits the use of standard equipment, such as splicing equipment, previously utilized with nominal 250 micron diameter optical fibers. For example, a typical ribbonized plurality of nominal 200 micron diameter optical fibers would have a nominal 200 micron pitch spacing throughout the ribbonized array. However, most standard equipment is suited for optical fibers which are ribbonized at a nominal 250 micron pitch spacing. Accordingly, improved ribbonizing methods and apparatus which can efficiently and precisely provide pitch conversions for optical fibers would be advantageous.

### BRIEF DESCRIPTION

Aspects and advantages of the invention will be set forth in part in the following description, or may be obvious from the description, or may be learned through practice of the invention.

In accordance with one embodiment, a method for ribbonizing a plurality of loose optical fibers is provided. The method includes aligning the plurality of loose optical fibers in a co-planer array. The method further includes securing the aligned plurality of loose optical fibers in a predetermined pitch spacing, wherein each of the plurality of optical fibers is free from others of the plurality of optical fibers. The method further includes loading the loose optical fibers into a fiber holder.

In accordance with another embodiment, a method for ribbonizing a plurality of loose optical fibers is provided. The method includes aligning the plurality of loose optical fibers in a co-planer array. The method further includes arranging the aligned plurality of loose optical fibers into a pitch control device such that the plurality of loose optical fibers are converted from a first pitch spacing to a second pitch spacing different from the first pitch spacing in the pitch control device. The method further includes securing the arranged plurality of loose optical fibers in the pitch control device. The method further includes loading the secured loose optical fibers into a fiber holder at the second pitch spacing.

In accordance with another embodiment, a ribbonizing assembly is provided. The ribbonizing assembly includes an alignment device comprising a slot. The ribbonizing assembly further includes a pitch control device including a plurality of fiber channels, the fiber channels each having a size, shape, and spacing which provide a predetermined pitch spacing. The ribbonizing assembly further includes a clamp operable to interact with the pitch control device. The ribbonizing assembly further includes a removable fiber holder.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF FIGURES

A full and enabling disclosure of the present invention, including the best mode thereof, directed to one of ordinary skill in the art, is set forth in the specification, which makes reference to the appended figures, in which:

FIG. 1 is a perspective view of a ribbonizing assembly during alignment of loose optical fibers in accordance with embodiments of the present disclosure;

FIG. 2 is a perspective view of a ribbonizing assembly after arranging, securing, and loading of the loose optical fibers in accordance with embodiments of the present disclosure;

FIG. 3 is a perspective view of a ribbonizing assembly during removal of a fiber holder in accordance with embodiments of the present disclosure;

FIG. 4 is a perspective view of a plate of an alignment device in accordance with embodiments of the present disclosure; and

FIG. 5 is a perspective view of a pitch control device in accordance with embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

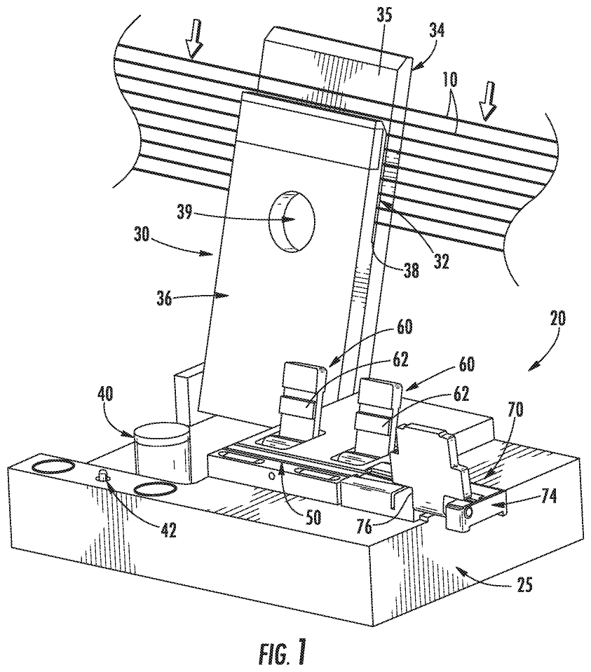

Referring now to FIGS. 1 through 5, methods and apparatus for ribbonizing optical fibers are provided. Methods and apparatus in accordance with the present disclosure provide numerous improvements and advantages over known ribbonizing processes. For example, methods and apparatus in accordance with the present disclosure advantageously facilitate relatively more efficient and precise ribbonizing. Further, such methods and apparatus may eliminate the need to glue, tape, or otherwise fasten the optical fibers together during the ribbonizing process, thus reducing or preventing contamination risks. Further, in exemplary embodiments, methods and apparatus in accordance with the present disclosure advantageously facilitate efficient and precise pitch conversion.

A plurality of loose optical fibers 10 may be provided for ribbonizing in accordance with the present disclosure. The loose optical fiber 10, by virtue of being loose, are not bound to each other in the form of a fiber optic ribbon. The optical fibers 10 can be single-mode optical fibers, multi-mode optical fibers, or otherwise. Further, the optical fibers can have any suitable nominal diameter. For example, in some embodiments, the nominal diameter of each optical fiber 10 in the plurality of loose optical fibers 10 may be 200 microns. Alternatively, the nominal diameter of each optical fiber 10 in the plurality of loose optical fibers 10 may be 250 microns. In still other embodiments, other suitable diameters may be utilized. Notably, the nominal diameter is the nominal outer diameter of the outermost layer of the optical fiber 10, which may for example be a secondary coating or a colorizing layer.

As shown, a ribbonizing assembly 20 may be utilized to ribbonize the plurality of loose optical fibers 10. Ribbonizing assembly 20 may, for example, include a base 25. Various other components of the ribbonzing assembly 20 may be attached to the base 25 in various configurations to form the ribbonizing assembly 20, as discussed herein.

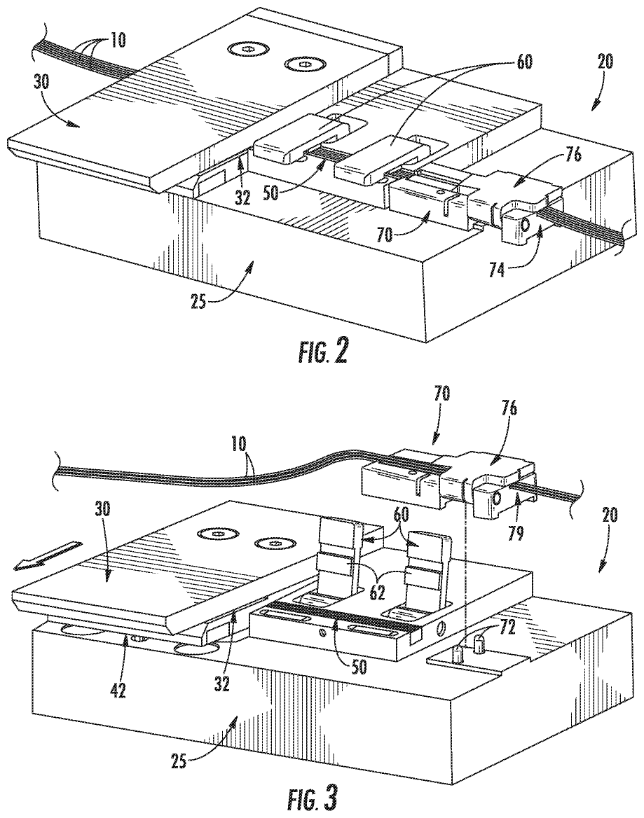

Ribbonizing assembly 20 may further include an alignment device 30. The alignment device 30 may be a pivotable device which is pivotable between two or more positions, such as a loading position as illustrated in FIG. 1, a ribbonizing position as illustrated in FIG. 2, and an unloading position as illustrated in FIG. 3. The unloading position may, for example, be between the loading position and the ribbonizing position. The alignment device 30 may, for example, be pivotally connected to the base 25, as shown. In these embodiments, the alignment device 30 may be pivotable relative to the base 25 between the various positions.

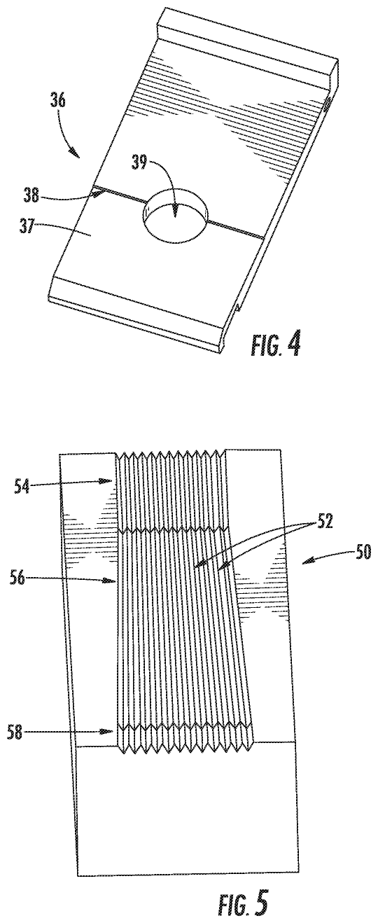

Alignment device 30 may include a slot 32 which may be defined between a first plate 34 and a second plate 36. First plate 34 may include a planar inner surface 35. As illustrated in FIG. 4, second plate 36 may include an inner surface 37 which defines a step 38. Additionally, a bore hole 39 may be defined through the plate 36, inner surface 37, and step 38.

The slot 32, or a first portion thereof, may extend to the step 38. This portion of the slot 32 may have a width which is slightly greater than the nominal diameter of the optical fibers 10 to be ribbonized. For example, the width of the slot 32 may be between 0% and 10%, such as between 2% and 8%, such as between 4% and 6%, greater than the nominal diameter of the optical fibers 10. Accordingly, the optical fibers 10 can be inserted into the slot 32. The step 38 may reduce or eliminate the width, such that the optical fibers 10 cannot be inserted into the slot 32 beyond the step 38. In some embodiments, the slot 32 terminates at the step 38. In other embodiments, the width of the slot 32 is reduced at the step 38 to less than the nominal diameter of the optical fiber 10.

Alignment device 30 may further include a post 40 which extends through the bore hole 39, and may further extend into the slot 32, when the alignment device is in the ribbonizing position. Post 40 may contact the optical fibers 10 which extend across the bore hole 39, holding the optical fibers 10 into position within the slot 32. When the alignment device 30 is in the loading and unloading positions, the post 40 may not contact the optical fibers 10, and may further not be disposed in the bore hole 39 and/or the slot 32. In some embodiments, post 40 extend from base 25, as shown.

Alignment device 30 may further include a plunger 42. In some embodiments, plunger 42 extends from base 25, as shown. Plunger 42 may further be movable relative to base 25 between a compressed position, as shown in FIG. 2, and an extended position, as shown in FIGS. 1 and 3. When the alignment device 30 is in the loading position or unloading position, the plunger 42 may be in the extended position. When the alignment device 30 is moved to the ribbonizing position, the plunger 42 may be in the compressed position. Plunger 42 may generally support the alignment device 30 in the unloading position such that the ribbonized fibers 10 can be unloaded therefrom.

Ribbonizing device 20 further includes a pitch control device 50. In some embodiments, the pitch control device 50 may be attached to the base 25, such as integral with the base 25 or embedded in the base 25 as shown. When embedded, at least a portion of the device 50 may be surrounded by the base 25. For example, the pitch control device 50 may be formed (such as via 3-D printing) separate, inserted into the base 25, and held in the base 25 with a set screw or other suitable fastener. In other embodiments, pitch control device 50 may be a portion of a fiber holder, as discussed herein. The pitch control device 50 may include a plurality of fiber channels 52 which extend in a co-planer, parallel manner. Each channel 52 may accommodate an optical fiber 10 therein. Further, the channels 52 may each have a size, shape, and spacing (relative to other channels 52) which provide a predetermined pitch spacing for the plurality of optical fibers 10 when arranged in the channels 52. The size, shape, and spacing of the channels 52 may, in some embodiments, be dependent upon the nominal diameter of the optical fibers 10, such that a desired predetermined pitch spacing is provided for the optical fibers 10 when arranged in the channels 52.

In some embodiments, the predetermined pitch spacing may be constant throughout the entire lengths of the channels 52, and thus throughout the pitch control device 50. Alternatively, the predetermined pitch spacing may be adjusted within the pitch control device 50, such as from a first pitch spacing to a second pitch spacing which is different from (such as larger or smaller than) the first pitch spacing. For example, referring to FIG. 5, each channel 52 may include a first end portion 54, an intermediate portion 56, and a second end portion 58. The first end portions 54 may provide a first pitch spacing. The second end portions 58 may provide a second pitch spacing. The intermediate portions 56 may provide a transition between the first and second pitch spacings. Accordingly, optical fibers 10 arranged in the pitch control device 50, such as in the channels 52 thereof, may be converted from a first pitch spacing to a second pitch spacing within the device 50 and channels 52 thereof.

In some embodiments, the first pitch spacing is nominal 200 microns and the second pitch spacing is 250 microns. Alternatively, other suitable first and second pitch spacings, and associated conversions therebetween, may be utilized.

Ribbonizing assembly 20 may further include one or more clamps 60, each of which may include a contact pad 62. Each clamp may be operable to interact with the pitch control device 50. For example, each clamp 60 may be a pivotable device which is pivotable between two or more positions, such as an open position as shown in FIGS. 1 and 3 and a closed position as shown in FIG. 2. In some embodiments, each clamp 60 may be pivotally connected to the base 25 and thus pivotable relative to the base 25. The clamps 60 may be utilized to secure the optical fibers 10 in position in the pitch control device 50. For example, in the open position, the clamps 60 may not be in contact with the device 50 or optical fibers 10 arranged therein. In the closed position, the clamps 60, such as the pads 62 thereof, may contact the optical fibers 10 and pitch control device 50, thus securing the optical fibers 10 in position in the pitch control device 50. Notably, in some embodiments, the interaction between the clamps 60 and the pitch control device 50 allows each optical fiber 10 to be free from the others of the plurality of optical fibers 10 (and thus not, for example, glued or taped together) during ribbonizing and/or use of the ribbonizing assembly 20.

Ribbonizing assembly 20 may further include a removable fiber holder 70. In general, any suitable fiber holder 70 may be utilized. The fiber holder 70 may, in some embodiments, be removably connected to the base 25, such as via alignment pegs 72 extending from the base 25 and corresponding holes defined in the fiber holder 70. In some embodiments pitch control device 50 is a separate component from the fiber holder 70, while in other embodiments pitch control device 50 is a component of the fiber holder 70. Fiber holder 70 may include a body 74 and a clamp 76 which is pivotally connected to the body 74.

The body 74 may include channels which may accommodate optical fibers 10 therein. Similar to channels 52, the channels of the body 74 may each have a size, shape, and spacing (relative to other channels) which provide a predetermined pitch spacing for the plurality of optical fibers 10 when arranged in the channels. The size, shape, and spacing of the channels may, in some embodiments, be dependent upon the nominal diameter of the optical fibers 10, such that a desired predetermined pitch spacing is provided for the optical fibers 10 when arranged in the channels. In some embodiments, the size, shape, and/or spacing may correspond to the size, shape, and spacing of the channels 52 at the second end portion 58. For example, in some embodiments, the channels may have the second pitch spacing.

The clamp 76 may be pivotally connected to the body 74 and pivotable between, for example, an open position as shown in FIG. 1 and a closed position as shown in FIGS. 2 and 3. In the open position, the clamp 76 may not be in contact with optical fibers 10 arranged in the fiber holder 70, such as in the body 74 thereof. In the closed position, the clamp 76 may contact the optical fibers 10, thus holding the optical fibers 10 in position in the fiber holder 70. The fiber holder 70 can then be removed from the ribbonizing assembly 20 and transported for use with other devices, such as for example, splicing, stripping, cleaning, cleaving, and/or other processing devices.

The present disclosure is further directed to methods for ribbonizing optical fibers 10. In some embodiments, such methods and/or one or more of the various steps thereof may be performed using a ribbonizing assembly 20 or one or more components thereof as discussed herein. However, it should be understood that performance of methods in accordance with the present disclosure are not limited to utilization of ribbonizing assemblies 20 or components thereof, and rather that such methods may be performed using any suitable apparatus. Reference to ribbonizing assemblies 20 or components thereof during discussion of methods for ribbonizing optical fibers 10 in accordance with the present disclosure are merely for illustrative purposes and are not intended to be limiting.

A method for ribbonizing a plurality of loose optical fibers 10 may, for example, include the step of aligning the plurality of loose optical fibers 10 in a co-planer array. When in the co-planer array, the loose optical fibers 10 (such as the portions of the optical fibers 10 in the array) may further be generally parallel to each other.

In exemplary embodiments, such alignment may include, and result from, inserting the loose optical fibers 10 into a slot 32 of an alignment device 30. For example, a first optical fiber 10 may be inserted into the slot 32 until it abuts against a step 38, and the remaining optical fibers 10 may be inserted into the slot 32 such that each optical fiber 10 abuts against neighboring optical fibers 10. In some embodiments such insertion may be performed with the alignment device 30 in a loading position, as illustrated in FIG. 1. Once the optical fibers 10 are aligned in the slot 32, the alignment device 30 may be rotated to a ribbonizing position, as illustrated in FIG. 2. In some embodiments, a post 40 may contact the optical fibers 10 in the ribbonizing position to hold the optical fibers 10 in place in the aligned co-planer array.

When the plurality of loose optical fibers 10 are aligned in the co-planer array, the optical fibers 10 if including colorizing layers may in exemplary embodiments be aligned in color-coded order.

A method in accordance with the present disclosure may further include, for example, the step of arranging the aligned plurality of loose optical fibers 10 at a predetermined pitch spacing. Such arrangement may, for example, be done in a pitch control device 50. For example, a user may, after performing the aligning step as discussed herein (optionally including rotation of an alignment device 30 from a loading position to a ribbonizing position), place further portions of the optical fibers 10 into a pitch-controlled arrangement (such as into a pitch control device 50, e.g. channels 52 thereof). Notably, during such arranging, the optical fibers 10 may in exemplary embodiments be free from each other (and thus not, for example, glued or taped together).

In exemplary embodiments, such arranging may occur such that the optical fibers 10 are converted from a first pitch spacing to a second pitch spacing which is different from (such as greater than or less than) the first pitch spacing. Such arrangement may, for example, be done in a pitch control device 50.

A method in accordance with the present disclosure may further include, for example, the step of securing the aligned plurality of loose optical fibers 10 in a predetermined pitch spacing, such as the predetermined pitch spacing provided during the arranging step. The securing step may occur, for example, after the aligning step and after the arranging step. Such predetermined pitch spacing may be a single pitch spacing throughout a portion of the plurality of loose optical fibers 10, or a conversion of a portion of the plurality of loose optical fibers 10 from a first pitch spacing to a second pitch spacing different from the first pitch spacing as discussed herein. Notably, during such securing, the optical fibers 10 may in exemplary embodiments be free from each other (and thus not, for example, glued or taped together).

In some embodiments, such as for example when a pitch control device 50 is utilized, the securing step may include clamping the plurality of loose optical fibers 10. For example, in some embodiments, clamps 60 may be pivoted from open positions to closed positions, as discussed herein.

A method in accordance with the present disclosure may further include, for example, the step of loading the loose optical fibers 10 into a fiber holder, such as fiber holder 70. Such step may, in some embodiments, occur after the securing step. The optical fibers 10 may, for example, be loaded into the fiber holder 70 at the predetermined pitch spacing. In some embodiments, the predetermined pitch spacing may be the second pitch spacing facilitated via a pitch conversion. Alternatively, such loading step may occur before the securing step. For example, the pitch control device 50 may be a portion of the fiber holder 70, and the predetermined pitch spacing may be adjusted during loading of the optical fibers 10 into the fiber holder 70. In these embodiments, clamp(s) 60 may be the clamp(s) 76 of the fiber holder 70. Such loading may include, for example, inserting portions of the secured optical fibers 10 into the fiber holder 70, such as into a body 74 thereof Such loading may further include, for example, pivoting a clamp 76 of the fiber holder 70 to a closed position which holds the optical fibers 10 such that the optical fibers 10 are loaded into the fiber holder 70.

In some embodiments, after such loading, the loaded optical fibers 10 may be unsecured. For example, in some embodiments, clamps 60 may be pivoted from closed positions to open positions. Further, in some embodiments, after such loading, the loaded optical fibers 10 may be removed from any arranging and aligning apparatus utilized during arrangement and alignment as discussed herein. Such removal may, in some embodiments such as when for example an alignment device 30 is utilized, include pivoting of the alignment device from a ribbonizing position to an unloading or loading position. After such pivoting, the optical fibers may be removed from the alignment device 30.

A method in accordance with the present disclosure may further include, for example, removing the loaded fiber holder 70 (such as from a ribbonizing assembly 20). Such removal may occur after loading as discussed herein, as well as after unsecuring and removal of arranging and aligning apparatus as discussed herein.

A method in accordance with the present disclosure may further include, for example, transporting the loaded fiber holder 70 to a splicing, stripping, cleaning, cleaving, and/or other processing device for subsequent processing thereof. Such transporting step may occur after removal as discussed herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for ribbonizing a plurality of loose optical fibers, the method comprising:
aligning the plurality of loose optical fibers in a co-planer array;
securing the aligned plurality of loose optical fibers in a predetermined pitch spacing, wherein each of the plurality of optical fibers is free from others of the plurality of optical fibers; and
loading the loose optical fibers into a fiber holder.

2. The method of claim 1, wherein the plurality of loose optical fibers each have a nominal diameter of 200 microns.

3. The method of claim 1, wherein the plurality of loose optical fibers each have a nominal diameter of 250 microns.

4. The method of claim 1, wherein aligning the plurality of loose optical fibers comprises inserting the plurality of loose optical fibers into a slot of an alignment device.

5. The method of claim 1, wherein securing the aligned plurality of loose optical fibers comprises clamping the aligned plurality of loose optical fibers.

6. The method of claim 1, further comprising arranging the aligned plurality of loose optical fibers into a pitch control device such that the plurality of loose optical fibers are arranged in the pitch control device at a predetermined pitch spacing, and wherein the securing step occurs after the arranging step.

7. The method of claim 6, wherein the plurality of loose optical fibers are converted from a first pitch spacing to a second pitch spacing different from the first pitch spacing in the pitch control device.

8. The method of claim 7, wherein the secured loose optical fibers are loaded into the fiber holder at the second pitch spacing.

9. The method of claim 7, wherein the second pitch spacing is greater than the first pitch spacing.

10. The method of claim 7, wherein the plurality of loose optical fibers each have a nominal diameter of 200 microns, the first pitch spacing is nominal 200 microns, and the second pitch spacing is nominal 250 microns.

11. A method for ribbonizing a plurality of loose optical fibers, the method comprising:
aligning the plurality of loose optical fibers in a co-planer array;
arranging the aligned plurality of loose optical fibers into a pitch control device such that the plurality of loose optical fibers are converted from a first pitch spacing to a second pitch spacing different from the first pitch spacing in the pitch control device;
securing the arranged plurality of loose optical fibers in the pitch control device; and
loading the secured loose optical fibers into a fiber holder at the second pitch spacing.

12. The method of claim 11, wherein the plurality of loose optical fibers each have a nominal diameter of 200 microns.

13. The method of claim 11, wherein aligning the plurality of loose optical fibers comprises inserting the plurality of loose optical fibers into a slot of an alignment device.

14. The method of claim 11, wherein securing the aligned plurality of loose optical fibers comprises clamping the aligned plurality of loose optical fibers.

15. The method of claim 11, wherein the second pitch spacing is greater than the first pitch spacing.

16. The method of claim 11, wherein the plurality of loose optical fibers each have a nominal diameter of 200 microns, the first pitch spacing is nominal 200 microns, and the second pitch spacing is nominal 250 microns.

17. A ribbonizing assembly, comprising:
an alignment device comprising a slot;
a pitch control device comprising a plurality of fiber channels, the fiber channels each having a size, shape, and spacing which provide a predetermined pitch spacing;
a clamp operable to interact with the pitch control device; and
a removable fiber holder.

18. The ribbonizing assembly of claim 17, further comprising a base, wherein the alignment device is pivotally connected to the base, the pitch control device is attached to the base, the clamp is pivotally connected to the base, and the removable fiber holder is removably coupled to the base.

19. The ribbonizing assembly of claim 17, wherein the fiber channels provide a predetermined pitch spacing adjustment from a first pitch spacing to a second pitch spacing different from the first pitch spacing.

20. The ribbonizing assembly of claim 19, wherein the first pitch spacing is nominal 200 microns and the second pitch spacing is nominal 250 microns.
